(19) United States
(12) Patent Application Publication
(10) Pub. No.: US 2024/0199362 A1
(43) Pub. Date: Jun. 20, 2024

(54) Calender Transport Roller and Calendering Device for the Production of Electrodes for a Battery Cell

(71) Applicant: Bayerische Motoren Werke Aktiengesellschaft, Muenchen (DE)

(72) Inventors: Wonsup HAN, Suwon-Si, Kwonsun-Ku (KR); Hyunchul ROH, Muenchen (DE); Nina ZENSEN, Pfaffenhofen an der Ilm (DE)

(21) Appl. No.: 18/554,880

(22) PCT Filed: Mar. 29, 2022
(86) PCT No.: PCT/EP2022/058291

§ 371 Date: Oct. 11, 2023

(30) Foreign Application Priority Data
Apr. 12, 2021 (DE) 10 2021 109 014.8

(51) Int. Cl. B65H 27/00; B65H 20/02; H01M 4/04

(52) U.S. Cl. CPC B65H 27/00; B65H 20/02; H01M 4/0435; B65H 2404/113; B65H 2404/1321; B65H 2404/411; B65H 2511/12; B65H 2801/72

(57) ABSTRACT

A calender transport roller for a calendering device for production of electrodes for a battery cell, where an electrode strip is conveyable by the calender transport roller to or from a pair of calendering rolls and where the electrode strip has a flat conductor strip and a coating which is applied in portions at least on a side that faces the calender transport roller. The calender transport roller includes a contact region on a shell surface of the calender transport roller where the contact region is contactable with the electrode strip, an adjusting portion in the contact region, and a widening device where a diameter of the transport roller in the adjusting portion is changeable by the widening device such that a height difference between a coated portion of the electrode strip and an adjoining uncoated portion of the electrode strip is compensated.

### BACKGROUND AND SUMMARY

The invention relates to a calender transport roller for a calendering device for the production of electrodes for a battery cell, in particular for a lithium-ion battery cell, which calender transport roller serves to convey an electrode strip to or from a pair of calendering rolls, the electrode strip comprising a flat conductor strip and a coating which is applied in portions at least on the side which faces the transport roller, the transport roller having a contact region on its shell surface, which contact region can come into contact with the electrode strip. Furthermore, the invention relates to a calendering device for the production of electrodes for a battery cell, in particular for a lithium-ion battery cell, with at least one pair of calendering rolls and at least one calender transport roller.

In order to manufacture electrodes for battery cells, in particular lithium-ion battery cells, flat conductor strips in the form of thin copper foil for the anode and aluminium foil for the cathode or corresponding metal meshes are provided on both sides with a coating consisting of a composite compound, the edges of the conductor strip remaining uncoated. After the application of the composite to the metallic conductor strip and possible removal of the carrier solvent, the electrode strip which is then coated on both sides is fed, usually in a roller to roller process, to a calendering device, where the coating is compressed by way of one or more pairs of rotating calendering rolls, in order to decrease or adjust the porosity and to increase the electrical conductivity and the energy density.

It is desirable here for the electrode strip to be fed as flatly, precisely and homogeneously as possible to the nip, which is configured between the calendering rolls, and to be transported out of this nip downstream of the calendering rolls. Since the electrode strip is also coated in portions on the side which faces the transport roller, it does not lie flatly on the transport roller over its complete width. There is a height difference between the coated portion and the adjoining uncoated edge portions, which height difference corresponds to the thickness of the single-sided coating of usually approximately from 30 μm to 100 μm (in the case of an overall thickness of the electrode strip of approximately from 80 μm to 200 μm). In comparison with this, the foil thickness of the conductor strip is only approximately from 6 μm to 25 μm.

In order to avoid the formation of folds, warped portions or cracks in the uncoated edge regions, it is common practice for the height difference between coated and uncoated portions to be compensated for by way of the manual application of adhesive tape to the calender transport roller. Here, the adhesive tape has to be applied in a highly exact manner, and has to be removed again and newly adhesively bonded for each new electrode strip which is to be compressed, in order to achieve the suitable adaptation in each case for different coating widths and coating heights. This manual adaptation is highly time-consuming and not always precise.

It is therefore the object of the present invention to provide a calender transport roller and a calendering device for the production of electrodes, by way of which a decrease in the preparation time and an improvement in the accuracy and therefore the quality of the compressed electrodes can be achieved.

In accordance with a first aspect of the invention, a calender transport roller of the type mentioned at the outset is provided to this end, the transport roller having at least one adjusting portion in its contact region, and a widening device being provided which changes the diameter of the transport roller in the adjusting portion, so as to compensate for a height difference between a coated portion of the electrode strip and an adjoining uncoated portion of the electrode strip.

It is to be noted that “contact region” is to be understood to mean the entire region of the shell surface of the transport roller which is contacted by the electrode strip or lies on the electrode strip. This region extends in the axial direction over a large part of the width of the transport roller and, in particular, can be larger than the adjusting portion. The calender transport roller serves purely for transporting the electrode strip to or from the calendering rolls, and is not a calendering roll itself.

In the case of the transport roller according to the invention, the diameter of the transport roller in the adjusting portion can be, in particular, mechanically changed (that is to say not, for instance, by way of thermal expansion or the like) in a targeted manner and can be adjusted to a desired value. As a result, a height difference between a coated portion and an adjoining uncoated portion of the electrode strip is compensated for with the formation of a step on the transport roller, with the result that flat feeding of the electrode strip to the calendering rolls is ensured, as a result of which undesired stresses and the formation of folds, cracks or warped portions of the conductor strip in the uncoated portions of the electrode strip are avoided. By way of the calender transport roller according to the invention, the quality of the produced electrodes can therefore be improved, which electrodes can also be rolled up more simply to form coils after the compression. Moreover, the following steps such as cutting the coils to size and, in particular, the cleanness of the contour cut which takes place mechanically or by way of laser, are facilitated decisively by way of flat and fold-free uncoated regions.

In comparison with a height compensation for each electrode strip by new adhesive tape which is applied manually to the transport roller, as has been customary up to now, the solution according to the invention additionally affords the advantage of a shorter preparation time during adjusting of the calendering device to a new electrode strip, and at the same time inaccuracies as a result of the manual adhesive bonding are avoided. Moreover, there is not the problem of contamination of the transport roller by way of adhesive tape residues which can remain after the removal of the adhesive tape. Here, the calender transport roller according to the invention can also be simply retrofitted an existing calendering devices, by merely the transport roller being exchanged, while the remaining facility remains unchanged.

A plurality of individual segments are preferably arranged in the adjusting portion next to one another in the axial direction of the transport roller, which segments can be widened in the radial direction of the transport roller independently of the respective adjoining segment. In the case of this refinement, the transport roller can be adapted particularly simply to electrode strips with coated portions of different width, by as many segments as necessary being widened to the greater diameter, in order to completely support the uncoated portion or portions of the electrode strip in its or their entire width.

The segments are configured, in particular, as rings or in a ring-like manner, it being possible for the segments to be slotted or to be divided into a plurality of ring portions in the circumferential direction.

Furthermore, the segments are preferably manufactured from steel, in particular stainless steel, particularly high precision being achieved during the adjustment of the desired diameter. In addition, the transport roller can be covered radially outside the segments with a solid rubber material which can be expanded somewhat, in order to provide a particularly homogeneous surface.

A particularly user-friendly refinement can be achieved if a widening mechanism which is operated by motor and individually actuates the segments electrically, hydraulically or mechanically is provided.

In order for it to be possible for the transport roller to be adapted in an optimum manner to different widths of the coated portion or portions of the respective electrode strip, the width of some or all the segments in the axial direction of the transport roller is advantageously at most 2 mm. In particular, the segments have a width of only approximately 1 mm.

The segments can be of correspondingly wide configuration in those axial regions of the transport roller or the contact region, in which there is usually no coating of the electrode strip.

The object mentioned at the outset is likewise achieved in accordance with the second aspect of the invention by way of a calender transport roller of the type mentioned at the outset, the transport roller having at least one adjusting portion with at least one prefabricated adjusting ring in its contact region, by the diameter of the transport roller changing such that a height difference between a coated portion of the electrode strip and an adjoining uncoated portion of the electrode strip is compensated for.

In the case of this variant of a transport roller according to the invention, the diameter of the transport roller in the adjusting portion can therefore be changed in a targeted manner and can be adjusted to the desired value via one or more prefabricated adjusting rings which form separate parts, with the result that a shoulder is produced in the transport roller. This also ensures flat feeding of the electrode strip to the calendering rolls, since a height difference between a coated portion and an uncoated portion of the electrode strip is compensated for, as a result of which undesired stresses and the formation of folds, cracks or warped portions of the uncoated regions of the conductor strip are avoided. Therefore, the quality of the produced electrodes can also be improved by way of this variant of the calender transport while according to the invention.

In comparison with a height compensation by way of a new adhesive tape applied manually onto the transport roller for each electrode strip, as has been customary up to now, this solution likewise affords the advantage of a shorter preparation time during adjusting of the calendering device to a new electrode strip, and at the same time inaccuracies as a result of the manual adhesive bonding are avoided. Moreover, there is not the problem of contamination of the transport roller by way of adhesive tape residues which can remain after the removal of the adhesive tape. Here, the calender transport roller according to the invention can also be simply retrofitted an existing calendering devices, by merely the transport roller being exchanged, while the remaining facility remains unchanged.

The at least one adjusting ring is preferably closed circumferentially.

In accordance with one preferred refinement, the adjusting ring or rings is/are made from steel, in particular stainless steel. As a result, particularly high precision during the adjusting of the desired diameter can be achieved.

The adjusting portion preferably comprises a plurality of adjusting rings which are arranged next to one another in the axial direction of the transport roller. The transport roller can thus be adapted particularly simply to coated portions of different width.

In one preferred refinement, the transport roller comprises a roller body of rigid configuration, on which at least one adjusting ring is arranged, in particular is pushed on, in the adjusting portion.

As an alternative to the adjusting ring being pushed on in the axial direction of the transport roller, as a result of which the latter has to be removed from the calendering device, it is also conceivable for the adjusting ring to be configured in two parts. In this case, in the case of a transport roller which is inserted into the calendering device, the two parts can be plugged onto this transport roller in the radial direction and can be coupled to one another, for example, by way of a latching connection.

In one particularly preferred embodiment, a plurality of adjusting rings of different radial thickness are provided which are arranged selectively in the adjusting portion on the roller body. In the case of this refinement, the transport roller can be adapted to different heights of the coated region by one or more adjusting rings being selected, by way of which the height difference between the coated portion and the uncoated portion of the electrode strip is compensated for exactly. Here, an entire set of different adjusting rings is therefore used, the appropriate ring or rings being used in each case.

The roller body can have a homogeneous diameter here. This affords the advantage that the at least one adjusting ring can be freely displaceable on the roller body in the axial direction of the transport roller. The axial position of the adjusting ring or rings is thus simply selected correspondingly, in order to adapt the transport roller to different widths of the coated portions of individual electrode strips.

Here, in one particularly preferred refinement, the adjusting portion extends over the entire contact region and comprises a plurality of adjusting rings which are arranged next to one another, even in the region, in which the electrode strip is coated. Here, the rigid roller body which lies beneath can have a considerably smaller diameter than the transport roller, which means that the adjusting rings have a comparatively great radial thickness, which facilitates the technical implementation and handling.

As an alternative, a middle region of the roller body can also have a greater diameter and can serve directly as support surface for the electrode strip. This region then defines the smallest possible width of the coating. The adjusting portions, in which the roller body has a smaller diameter, lie adjacently with respect to the middle region toward the axial edges of the transport roller. In the adjusting regions, adjusting rings of different radial thickness are arranged depending on requirements, in particular are pushed on in the axial direction. An adaptation to the width of the coated region of the electrode strip takes place by suitable adjusting rings being used, the radial thickness of which corresponds precisely to the difference between the diameter of the roller body in the middle region and the diameter in the adjusting portion. In addition, further adjusting rings with a greater radial thickness are used, in order to compensate for the height difference in those regions of the adjusting portion, in which there is no coating of the electrode strip. Since, in the case of this refinement (in comparison with a solution, in the case of which the radial thickness of the adjusting rings corresponds merely to the height of the single-sided coating of the electrode strip of approximately from 30 μm to 100 μm), the adjusting rings can be of thicker and therefore more stable configuration in the radial direction, this variant affords advantages with regard to the technical implementation and the handling.

It would theoretically also be conceivable that a plurality of adjusting rings with different diameters are provided which are selectively arranged above one another on the roller body in the adjusting portion. These rings have, in particular, the same radial thickness; the adaptation to the respective height difference between the coated and uncoated portions of the electrode strip is achieved by virtue of the fact that the corresponding number of the adjusting rings are arranged above one another. Therefore, the radial thickness of the individual adjusting rings defines the minimum steps, in which the adaptation can take place.

One particularly preferred embodiment of the invention provides that the adjusting portion extends in the axial direction of the transport roller over its entire contact region. This makes an optimum adaptation to different heights and widths of the coating of the electrode strip possible, both in the case of the variant with segments which can be widened and also in the case of the variant with adjusting rings. The precise transport of electrode strips which have two or more coated portions over their width, between which an coated portions are likewise provided, is also possible.

As an alternative, a plurality of adjusting portions can be arranged in the axial direction of the transport roller, in particular at least two adjusting portions which are arranged close to the axial ends of the transport roller. The diameter of the transport roller is then unchangeable between the adjusting portions, which represents a less expensive variant which can also be adjusted in a less variable manner, however. Here too, at least one adjusting portion can additionally be arranged in a middle region (in relation to the axial direction of the transport roller), whereby electrode strips which have a multiple-track coating can also be transported without faults.

In order to achieve a particularly accurate adaptation to different heights of the coating, the adjusting rings or segments are preferably configured in such a way that the diameter of the transport roller in the adjusting portion can be adapted in steps which lie between 10 μm and 30 μm. In this way, the transport roller can therefore be adapted to different coating heights in steps of from 5 μm to 15 μm. In the case of adjusting rings arranged above one another, the thickness of the (thinnest) rings would therefore correspondingly be from 5 to 15 μm; in the case of adjusting rings with different radial thicknesses which are optionally used, the steps of the ring set have to be selected correspondingly. In the case of segments which can be widened, the widening steps have to be defined correspondingly. It can be sufficient here if these fine steps are possible around a middle value of the coating height.

In accordance with a third aspect of the invention, a calendering device for the production of electrodes for a battery cell, in particular for a lithium-ion battery cell, is provided. This calendering device comprises at least one pair of calendering rolls and at least one transport roller, as has been previously described. Here, the transport roller conveys the electrode strip toward a nip which is configured between the calendering rolls. In the case of this transport roller which serves as a feed to the calendering rolls, the precise and fold-free transport of the electrode strip is particularly decisive, in order to achieve high quality electrodes. The calendering device according to the invention therefore affords high flexibility and rapid adaptation to different electrode strips. With regard to the further advantages, reference is made at this point to the comments in respect of the calender transport rollers according to the independent claims.

In one development, in the case of a calendering device, a second transport roller according to the invention is provided which is arranged immediately downstream of the pair of calendering rolls in a running direction of the electrode strip. In this way, the quality of the produced electrodes can be improved further, the diameter of the second calender transport roller of course being adapted in portions to the height difference between coated and uncoated portions of the electrode strip after compression of the coating.

Further features and advantages result from the following description of a plurality of preferred embodiments on the basis of the appended drawings.

### BRIEF DESCRIPTION OF THE DRAWINGS

FIG. 1 shows a diagrammatic side view, partially sectioned, other calender transport roller in accordance with a first embodiment of the invention which transports an electrode strip;

FIG. 2 shows a diagrammatic plan view of the kind a transport roller from FIG. 1;

FIG. 3 shows a diagrammatic side view, partially sectioned, other calender transport roller in accordance with a second embodiment of the invention which transports an electrode strip;

FIG. 4 shows a diagrammatic side view, partially sectioned, other calender transport roller in accordance with a third embodiment of the invention which transports an electrode strip;

FIG. 5 shows a diagrammatic side view, partially sectioned, other calender transport roller in accordance with a fourth embodiment of the invention which transports an electrode strip;

FIG. 6 shows a diagrammatic side view, partially sectioned, of a calender transport roller in accordance with a fifth embodiment of the invention which transports an electrode strip;

FIG. 7 shows a diagrammatic side view, partially sectioned, of a calender transport roller in accordance with a sixth embodiment of the invention which transports an electrode strip; and

FIG. 8 shows a diagrammatic view of a calendering device according to the invention.

### DETAILED DESCRIPTION OF THE DRAWINGS

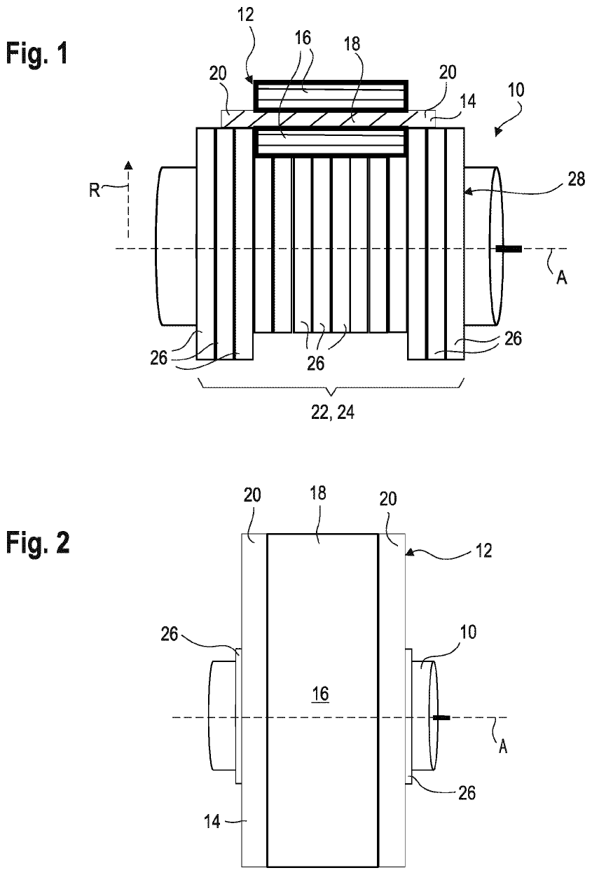

FIGS. 1 and 2 show a calender transport roller 10 in accordance with a first embodiment of the invention which is used in a calendering device 1 (see FIG. 8) for the production of electrodes for a battery cell, in particular a lithium-ion battery cell. The transport roller 10 serves to convey an electrode strip 12 to and from a pair of calendering rolls 2. The electrode strip 12 has a flat conductor strip 14, which is a metal mesh or metal foil unwound from a reel. Aluminum foil is used to produce a cathode, and copper foil is used to produce an anode. The foil thicknesses are between 6 μm and 25 μm.

The conductor strip 14 is provided on both sides in portions of the coating 16 which consists of composite compound and the thickness of which is in each case approximately from 30 μm to 100 μm. The coating 16 is a suspension which is applied as a wet film and is subsequently dried. As an alternative, a pressing application or an application of an extruded viscous compound in what is known as a solvent-free “dry coating process” or extrusion process is possible. The width of the coating 16 is approximately from 70 mm to 430 mm.

The coating 16 results in a height difference on the side which faces the transport roller 10 between a coated portion 18 of the electrode strip 12 and two adjoining uncoated portions 20 of the electrode strip 12 which lie on the edge region. The width of the uncoated edges of the electrode strip 12 is usually between 0.5 cm and 10 cm, here approximately 2 cm.

It is to be noted that the figures serve merely for illustration and are not true to scale.

In order to prevent a mechanical deformation of the sensitive conductor strip 14 and the formation of folds, cracks and the warped portions in the uncoated portions 20, the electrode band 12 has to be fed as homogeneously as possible to a nip 4 (cf. FIG. 8) which is configured between the calendering rolls 2. For this purpose, the transport roller 10 has, in a contact region 22 which can be contacted by the electrode band 12 on the shell surface of the transport roller 10, an adjusting portion 24 which, in the case of the embodiment according to FIGS. 1 and 2, extends over the entire contact region 22 in the axial direction A of the transport roller 10.

A multiplicity of individual segments 26 are arranged next to one another in the axial direction A of the transport roller 10 in the adjusting portion 24, which segments can be widened in the radial direction R of the transport roller 10 with the aid of a radially inner widening device 28, by the widening device 28 changing the diameter of the transport roller 10 in the adjusting portion 24, to be precise for each individual segment 26 independently of the respective neighboring segment.

The segments 26 are made from stainless steel and, in particular, are of annular configuration, the rings being slotted in the circumferential direction or even being divided into a plurality of ring portions. The segments 26 can additionally be coated radially on the outside with a solid rubber material which can be expanded somewhat.

The widening device 28 comprises a widening mechanism which is operated by motor and individually actuates each segment 26 electrically, hydraulically, pneumatically or mechanically. Since the widening steps preferably lie in the range of approximately 10 μm, precision mechanical actuation is necessary.

By way of the widening in portions of the adjusting portion 24 or individual segments 26, the transport roller 10 is adjusted to the respective electrode strip 12 to be transported, in such a way that the height difference between the coated portion 18 of the electrode strip 12 and the two adjoining uncoated portions 20 is compensated for.

The width of each segment 26 in the axial direction A of the transport roller 10 is preferably only a few millimeters, in particular in the transition regions between the coated portion 18 and the uncoated portions 20. In the middle region, in which the continuous coating 16 is present, the segments 26 can be of correspondingly wider configuration, and likewise on the radially outer edges of the adjusting portion 24.

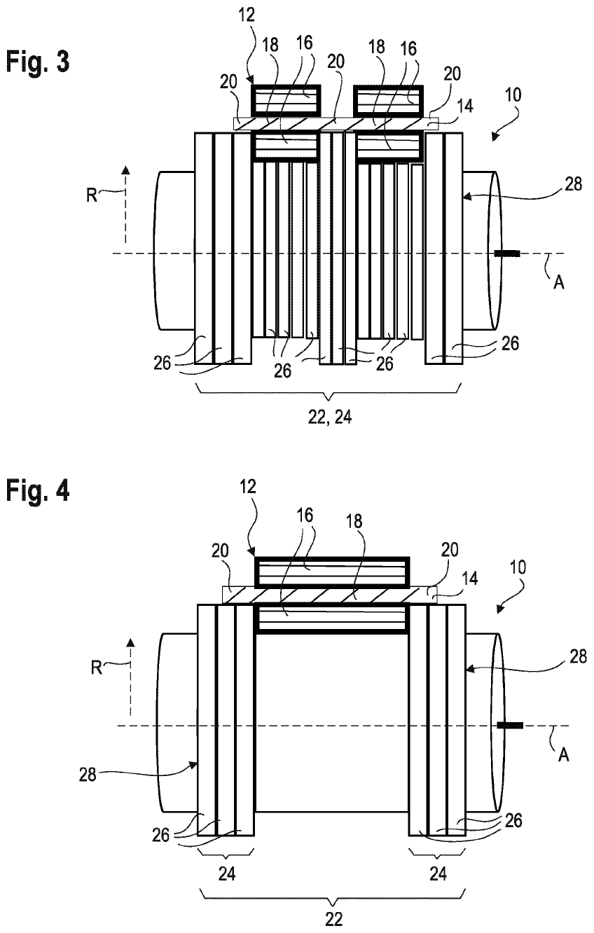

FIG. 3 shows a second embodiment of the calender transport roller 10, identical components having identical designations in the following text, and merely the differences to the previously described embodiment being explained.

The transport roller 10 according to FIG. 3 differs from that from FIG. 1 merely in that the individual segments 26 are of narrower configuration in a middle region of the adjusting portion 24 in the axial direction A, while there are somewhat wider segments 26 in the edge region.

In addition, in the case of the embodiment which is shown, the electrode strip 12 has two coated portions 18, between which a further uncoated portion 20 of the electrode strip 12 is provided. In order to also avoid the formation of folds and the like in this region, the segments 26 are also widened here, with the result that the height difference between the coated portions 18 and the uncoated portion 20 which lies in between is compensated for.

As can be seen from FIG. 3, the width of the uncoated portion 20 which lies between the coated portions 18 is approximately twice as great as the width of the uncoated portions 20 on the two edges of the electrode strip 12.

FIG. 4 shows a third embodiment of the calender transport roller 10, in the case of which the adjusting portion 24 does not extend over the entire contact region 22, but rather two adjusting portions 24 which are each arranged close to an axial end of the transport roller 10 are provided in the axial direction A of the transport roller 10. The diameter of the transport roller 10 is unchangeable between the adjusting portions 24, as a result of which the minimum width which the coating 16 must have is predefined.

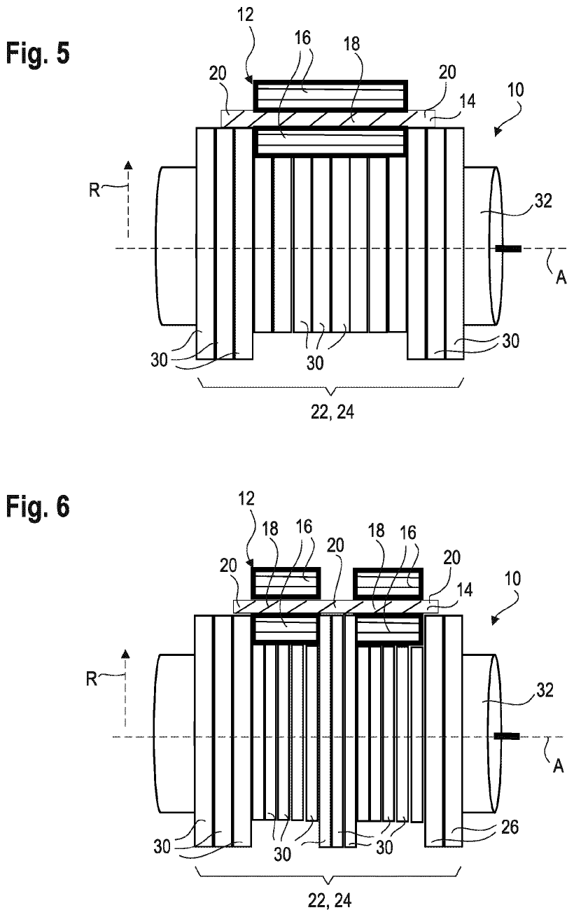

FIG. 5 shows a fourth embodiment of the calender transport roller 10 according to the invention, merely the differences to the previously described embodiments also being explained here. The calender transport roller 10 according to FIG. 5 has an adjusting portion 24 which extends in the axial direction A of the transport roller over its entire contact region 22.

Individual segments which can be widened are not provided here in the adjusting portion 24, however, but rather a plurality of prefabricated adjusting rings 30, by way of which the diameter of the transport roller 10 can be changed in such a way that the height difference between the coated portion 18 of the electrode strip 12 and the uncoated portions 20 is compensated for.

The adjusting portion 24 has a multiplicity of adjusting rings 30 which are arranged next to one another in the axial direction A of the transport roller 10.

The adjusting rings 30 are circumferentially closed and are manufactured from steel, in particular stainless steel. The adjusting rings 30 are arranged on a roller body 32 of rigid configuration of the transport roller 10, in particular are pushed on laterally.

Here, the adjusting rings 30 which make contact with the electrode strip 12 or the conductor strip 14 in the uncoated portions 20 have a greater radial thickness than the adjusting rings 30 which support the coated portion 18 of the electrode strip 12.

For adaptation of the transport roller 10 to the respective electrode strip 12, the respective appropriate adjusting rings 30 which are adapted in an optimum manner to the respective electrode strip 12 to be transported are selected from a multiplicity of adjusting rings 30 which have different radial thicknesses. To this end, there is an entire set of adjusting rings 30, the radial thicknesses of which are stepped approximately in 10 μm portions, the respective rings which are appropriate for the present coating 16 being selected. The roller body 32 has a uniform diameter, onto which adjusting rings 30 are pushed in the entire contact region 22.

Here too, the width of each adjusting ring 30 in the axial direction A of the transport roller 10 lies in the range of a few millimeters, which makes as accurate an adaptation is possible to the width of the coating 16 possible.

FIG. 6 shows a calender transport roller 10 in accordance with a fifth embodiment of the invention, in the case of which the adaptation to the height difference between the coated portions 18 and the adjoining uncoated portions 20 of the electrode strip 12 takes place by way of a plurality of adjusting rings 30 which are arranged in the adjusting portion 24. In a similar manner to the embodiment according to FIG. 3, the electrode band 12 also has two coated portions 18 here, between which an uncoated portion 20 is again provided. It is conspicuous that the adjusting rings 30 are of somewhat narrower configuration in the axial width here than in the case of the embodiment according to FIG. 5, at least in a middle region of the adjusting portion 24.

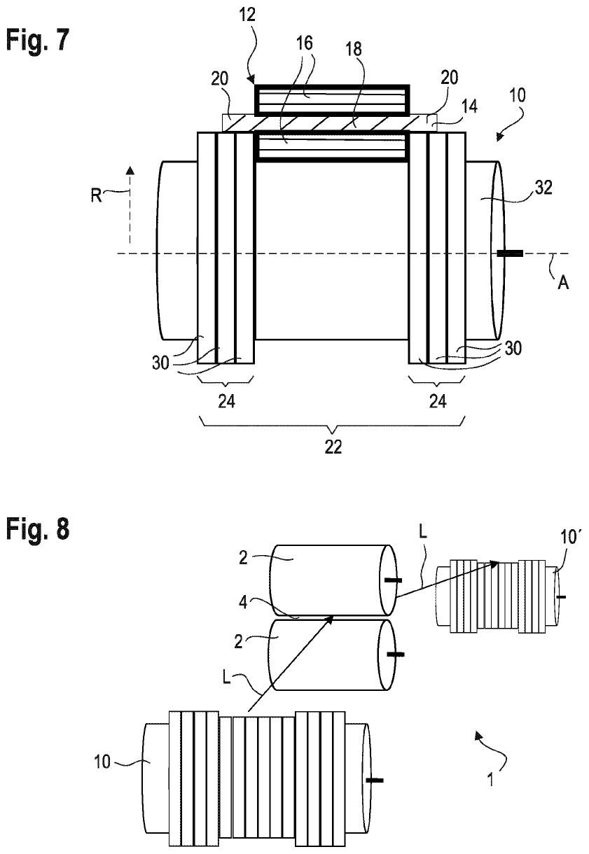

A calender transport roller 10 in accordance with a sixth embodiment of the invention is shown in FIG. 7. Here too, the height differences between the coated portion 18 and the uncoated portions 20 is compensated for by way of adjusting rings 30. Here, similarly to the embodiment according to FIG. 4, two adjusting portions 24 are provided which are arranged close to the axial ends of the transport roller 10. In a middle portion of the contact region 22, in which the coated portion 18 of the electrode strip 12 is arranged, the roller body 32 serves directly as a contact surface for the electrode band 12 or the coating 16.

In the case of the embodiment which is shown, the roller body 32 has a uniform diameter; as an alternative, however, it would also be conceivable that the middle part of the roller body 32 which makes direct contact with the coating 16 has a greater diameter, and the roller body 32 has a smaller diameter in the region of the adjusting portions 24. An embodiment of this type affords the advantage that the adjusting rings 30 can be of thicker configuration in the radial direction R, which can be implemented in a technically simpler manner.

Finally, FIG. 8 shows a calendering device 1 according to the invention for the production of electrodes which comprises a pair of calendering rolls 2 and two transport rollers 10, 10′, the transport roller 10 conveying the electrode strip 12 toward the nip 4 which is configured between the calendering rolls 2.

The coating 16 is compressed between the calendering rolls 2, in order to decrease its porosity, as a result of which an improved structure of the surface and an improved conductivity and a higher energy density can be achieved.

The second transport roller 10′ is arranged downstream of the calendering rolls 2 in the running direction L of the electrode strip 12, and transports the finally compressed electrode strip 12 further to a rolling-up device, in which the coated and compressed electrode strip 12 is rolled up to form a coil (not shown in the figure).

1.-14. (canceled)

15. A calender transport roller for a calendering device for production of electrodes for a battery cell, wherein an electrode strip is conveyable by the calender transport roller to or from a pair of calendering rolls and wherein the electrode strip has a flat conductor strip and a coating which is applied in portions at least on a side that faces the calender transport roller, comprising:
a contact region on a shell surface of the calender transport roller, wherein the contact region is contactable with the electrode strip;
at least one adjusting portion in the contact region; and
a widening device, wherein a diameter of the transport roller in the at least one adjusting portion is changeable by the widening device such that a height difference between a coated portion of the electrode strip and an adjoining uncoated portion of the electrode strip is compensated.

16. The calender transport roller according to claim 15, wherein a plurality of segments are disposed in the at least one adjusting portion next to one another in an axial direction of the calender transport roller and wherein segments of the plurality of segments are widenable in a radial direction of the calender transport roller independently of a respective adjoining segment.

17. The calender transport roller according to claim 16, further comprising a widening mechanism which is operated by a motor and which individually actuates the plurality of segments electrically, hydraulically or mechanically.

18. The calender transport roller according to claim 16, wherein segments of the plurality of segments or all the plurality of segments have a width of at most 2 mm in the axial direction.

19. A calender transport roller for a calendering device for production of electrodes for a battery cell, wherein an electrode strip is conveyable by the calender transport roller to or from a pair of calendering rolls and wherein the electrode strip has a flat conductor strip and a coating which is applied in portions at least on a side that faces the calender transport roller, comprising:
a contact region on a shell surface of the calender transport roller, wherein the contact region is contactable with the electrode strip; and
at least one adjusting portion that has at least one prefabricated adjusting ring in the contact region, wherein a diameter of the transport roller is changeable by the at least one prefabricated adjusting ring such that a height difference between a coated portion of the electrode strip and an adjoining uncoated portion of the electrode strip is compensated.

20. The calender transport roller according to claim 19, wherein the at least one prefabricated adjusting ring is closed circumferentially.

21. The calender transport roller according to claim 19, wherein the at least one prefabricated adjusting ring is made from steel.

22. The calender transport roller according to claim 19, wherein the at least one adjusting portion has a plurality of prefabricated adjusting rings which are disposed next to one another in an axial direction of the calender transport roller.

23. The calender transport roller according to claim 19, further comprising a roller body of rigid configuration, wherein the at least one prefabricated adjusting ring is disposed on the roller body.

24. The calender transport roller according to claim 23, wherein the at least one adjusting portion has a plurality of prefabricated adjusting rings of different respective radial thickness which are disposed on the roller body.

25. The calender transport roller according to claim 15, wherein the at least one adjusting portion extends in an axial direction of the calender transport roller over an entirety of the contact region.

26. The calender transport roller according to claim 15, wherein the at least one adjusting portion is a plurality of adjusting portions that are disposed in an axial direction of the calender transport roller.

27. A calendering device for production of electrodes for a battery cell, comprising:
a pair of calendering rolls; and
a first calender transport roller according to claim 15, wherein an electrode strip is conveyable by the first calender transport roller toward a nip which is configured between the pair of calendering rolls.

28. The calendering device according to claim 27, further comprising a second transport roller according to claim 15 which is disposed immediately downstream of the pair of calendering rolls in a running direction of the electrode strip.
